(19) United States
(12) Patent Application Publication
(10) Pub. No.: US 2005/0068992 A1
(43) Pub. Date: Mar. 31, 2005

(54) Method and apparatus for high-speed data multiplexing

(76) Inventors: Vicky B. Kaku, San Diego, CA (US); James R. Heaton, Ramona, CA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/949,500

(22) Filed: Sep. 24, 2004

Related U.S. Application Data
(60) Provisional application No. 60/506,274, filed on Sep. 26, 2003.

(51) Int. Cl. H04L 12/56

(52) U.S. Cl. 370/535

(57) ABSTRACT

The present method and apparatus provide high-speed data multiplexing of telecommunications data signals. In one of many possible embodiments, an apparatus provides for high-speed multiplexing of Motion Picture Experts Group (MPEG) transport streams in a cable network. The apparatus includes an input interface, a demultiplexer, and an output interface. The input interface is configured to receive a number of transport streams carrying programming services. The demultiplexer is configured to access user-defined logic and to generate the internal transport streams based on the user-defined logic. The demultiplexer is further configured to add the programming services to at least one of the internal transport streams based on the user-defined logic. The output interface is configured to output the internal transport streams.

### RELATED APPLICATIONS

This application claims priority under 35 U.S.C. §119(e) to U.S. Provisional Patent Application Ser. No. 60/506,274, filed on Sep. 26, 2003, the contents of which are hereby incorporated by reference in their entirety.

### FIELD

The present method and apparatus relate to telecommunications. More specifically, the present method and apparatus relate to high-speed data multiplexing of telecommunications data signals.

### BACKGROUND

People have generally come to rely on telecommunications more than ever before. The growing demand for telecommunications services has fueled improvements in the capabilities of devices and protocols designed to reliably and quickly process and transmit the service signals. For example, video-on-demand (VOD) services now allow subscribers to order and view video programs anytime.

However, VOD services are highly demanding of resources. In satellite or cable television communications for example, a VOD program is typically assigned to a single telecommunications transport stream that delivers the video program signals to the subscriber. When many people order different programs, bandwidth and other system resources are quickly consumed. Moreover, the increasing number of program signals being requested and delivered to specific subscriber locations at selectable times complicates the processing, routing, and delivery of VOD programs. There exists a need for telecommunications devices that have improved capabilities for flexibly and quickly processing large quantities of telecommunications signals, especially demanding signals such as video-on-demand.

Further, in mixed-protocol networks, video program signals are typically transmitted to subscribers using different transmissions protocols and mediums. One common protocol used for compressing video programs for transmission is known as Motion Picture Experts Group (MPEG). A video program can be represented and transmitted as an MPEG transport stream over mediums such as digital video broadcast over asynchronous serial interfaces (commonly referred to as ASI) and gigabit Ethernet (GigE). Each transport stream may carry single or multiple service programs. While GigE mediums are generally capable of higher performance when compared with ASI mediums, ASI compliant devices are already deployed in many networks. Therefore, it is desirable for telecommunications devices to support different types of video transport streams.

### SUMMARY

The present method and apparatus provide high-speed data multiplexing of telecommunications data signals. In one of many possible embodiments, an apparatus provides for high-speed multiplexing of Motion Picture Experts Group (MPEG) transport streams in a cable network. The apparatus includes an input interface, a demultiplexer, and an output interface. The input interface is configured to receive a number of transport streams carrying programming services. The demultiplexer is configured to access user-defined logic and to generate the internal transport streams based on the user-defined logic. The demultiplexer is further configured to add the programming services to at least one of the internal transport streams based on the user-defined logic. The output interface is configured to output the internal transport streams.

### BRIEF DESCRIPTION OF THE DRAWINGS

The accompanying drawings illustrate various embodiments of the present method and apparatus and are a part of the specification. Together with the following description, the drawings demonstrate and explain the principles of the present method and apparatus. The illustrated embodiments are examples of the present method and apparatus and do not limit the scope thereof.

FIG. 1 is a block diagram illustrating an implementation of SEM devices in a cable network, according to one embodiment.

FIG. 2 is a block diagram illustrating input and output ports of the SEM device of FIG. 1, according to one embodiment.

FIG. 3 is a block diagram illustrating high-level components of the SEM device of FIG. 1, according to one embodiment.

FIG. 4 is a block diagram illustrating components of the multiplexer field-programmable gate array (FPGA) of FIG. 3, according to one embodiment.

FIG. 5 is a block diagram illustrating components of the demultiplexer of FIG. 4, according to one embodiment.

FIG. 6 is a map of an exemplary lookup table implemented in synchronous dynamic random access memory (SDRAM) of FIG. 4, according to one embodiment.

FIG. 7 is a flowchart diagram illustrating a method for multiplexing transport streams, according to one embodiment.

Throughout the drawings, identical reference numbers designate similar, but not necessarily identical, elements.

### DETAILED DESCRIPTION

I. Introduction

The present specification describes apparatuses and methods for high-speed data multiplexing. More specifically, the present apparatuses and methods provide the ability to multiplex and otherwise process large quantities of MPEG data at high speeds. This can be accomplished by implementing logic and devices configured to perform aliasing, duplicating, demultiplexing, multiplexing, and routing functions on MPEG transport streams. A host controller operating in the background can receive logic configurations from a cable operator and load the logic configurations into a lookup table. The values in the lookup table can be accessed and entries identified based on packet and source identifiers association with the MPEG transport streams. The MPEG transport streams are then multiplexed according to the identified values in the lookup table. With these features and the features described below, the present apparatuses and methods can be implemented to provide high-speed multiplexing and reliable delivery of data transport streams carrying audio/video programs (e.g., video-on-demand programs) to subscribers over cable, satellite, or other networks.

In addition, the present methods and apparatuses can be configured to receive and process MPEG data in different formats (e.g., Ethernet and ASI). The MPEG data can then be output in different formats, including Ethernet, ASI, and quadrature amplitude modulation (QAM) radio frequency (RF) outputs. This allows cable operators to implement the present methods and apparatuses to utilize the speed of Ethernet technologies while still leveraging already-deployed ASI units.

In the following description, for purposes of explanation, numerous specific details are set forth in order to provide a thorough understanding of the present method and apparatus for high-speed data multiplexing. It will be apparent, however, to one skilled in the art that the present apparatus and method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

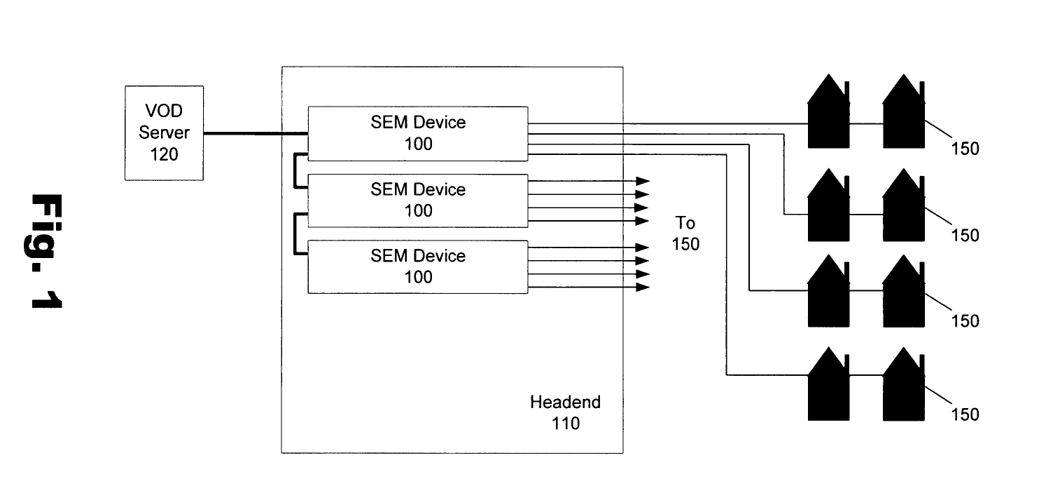

FIG. 1 is a block diagram illustrating an implementation of a number of super encryption modulation (SEM) devices (100) in a cable network, according to one embodiment. In the cable network shown in FIG. 1, the SEM devices (100) are included in a cable headend (110) (or simply the “headend (110)”). The cable headend (110) is communicatively coupled to a video-on-demand (VOD) server (120) such that the SEM devices (100) are able to receive data transport streams (also referred to as audio/video transport streams or simply transport streams) from the VOD server (120). In other embodiments, the VOD server (120) may be located in the cable headend (110). While only one VOD server (120) is shown in FIG. 1, multiple VOD servers (120) can feed data transport streams to the SEM devices (100).

As will be discussed in detail below, the SEM devices (100) are configured to process the received data transport streams in preparation for sending multiplexed output transport streams downstream to subscriber locations (150). Communication mediums and protocols between the headend (110) and the subscriber locations (150) may comprise any communications mediums and protocols known to those skilled in the art, including but not limited to fiber optics, coaxial cable, hybrid fiber-coax, wireless, Ethernet, ASI, radio frequency (RF), etc.

While FIG. 1 shows specific numbers of the SEM devices (100), cable headends (110), VOD servers (120), and subscriber locations (150), it will be appreciated by those skilled in the art that different numbers of these items can be employed in the cable network. Moreover, the SEM device (100) is not limited to cable network applications. For example, the SEM device (100) can be employed in satellite networks that provide encrypted audio/visual programming to subscribers.

The cable network shown in FIG. 1 enables delivery of audio/visual programs (e.g., television programs) to the subscribers (150) via data transport streams. The data transport streams carry data representative of the programs. The headend (110), which can include any type of cable or satellite system operator (e.g., a local cable operator (LCO) or a multi-service operator (MSO)), typically transmits numerous transport streams downstream toward the subscriber locations (150), and receives signals upstream from the subscriber locations (150). Usually, the cable headend (110) directs the transmission of downstream transport streams such that appropriate service programs are delivered to appropriate subscribers. For example, a particular subscriber may subscribe to a certain package of service programs. The headend (110) can implement logic that directs the routing of the correct service programs to the particular subscriber. With video-on-demand programs, subscribers are able to dynamically order specific programs. With the SEM device (100), the headend (110) is able to configure and update logic that directs the routing and delivery of service programs to subscribers via transport streams.

The transport streams can be in the form of different signaling protocols. For example, the VOD server (120) and/or the headend (110) are able to provide transport streams in MPEG (e.g., MPEG-2) format, which includes streams of MPEG packetized data. The SEM device (100) receives and processes the MPEG transport streams. The SEM device (100) is configured to selectively encrypt and route the MPEG transport streams to appropriate subscriber locations (150) based on routing instructions defined by the cable operator in the SEM device (100). The SEM device (100) can then output service program signals to appropriate subscribers at the subscriber locations (150). These functions and features of the SEM device (100) will be described in detail below.

In the context of video-on-demand programs, a subscriber at a particular subscriber location (150) may request delivery of a video-on-demand (VOD) program. In response, the VOD server (120) provides the requested VOD program, and the SEM device (100) at the headend (110) receives a transport stream containing data representative of the requested program. The SEM device (100) processes the transport stream in accordance with parameters defined by the cable operator to prepare output containing data representative of the requested program for transmission to the subscriber locations (150). As will be discussed below, the SEM device (100) is configured to process large quantities of such transport streams in this manner to provide high-speed multiplexing and reliable delivery of service programs to the subscriber locations (150).

MPEG data transport streams can be propagated through the cable network of FIG. 1 using different data communications technologies. For example, the SEM device (100) can be configured to receive MPEG-2 transport streams via Ethernet technologies (e.g., gigabit Ethernet (GigE) and/or asynchronous serial interface (ASI) technologies. This allows cable operators to employ the SEM device (100) in mixed networks utilizing various technologies. With the SEM device (100), cable operators can utilize newer technologies (e.g., GigE) while leveraging already-deployed technologies (e.g., ASI).

II. SEM Device Inputs and Outputs

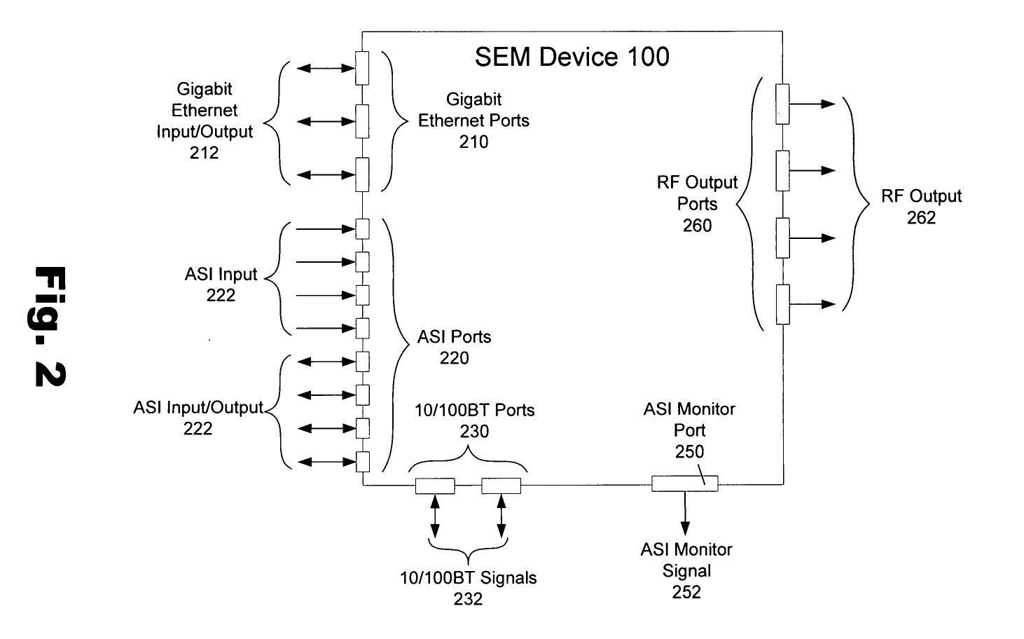

FIG. 2 is a block diagram illustrating input and output ports of the SEM device (100) of FIG. 1, according to one embodiment. As shown in FIG. 2, the SEM device (100) includes a number of ports for receiving input and sending output signals of different types.

A. GigE Ports

The SEM device (100) can include gigabit Ethernet (GigE) ports (210) configurable for receiving and/or transmitting GigE input and/or output (212). The GigE ports (210) can comprise small form factor pluggable (SFP) optical interfaces. FIG. 1 shows three gigabit Ethernet ports (210). In one embodiment, two GigE ports (210) are configured for input, and one GigE port (230) is configured for output. Transport streams of MPEG-2 program data in GigE format may be received and transmitted through the GigE ports (230). In one embodiment, up to 1,024 audio transport streams or up to 256 video transport streams can be concurrently received by the SEM device (100) via the GigE ports (210). The SEM device (100) can be configured to handle an aggregate input bandwidth on the GigE ports (210) of up to nearly one gigabit per second (e.g., 900 Mbits per second).

B. ASI Ports

FIG. 2 further shows the SEM device (100) to include a number of asynchronous serial interface (ASI) ports (220) for receiving and sending ASI input/output (222). The ASI ports (220) can comprise Bayonet Neill Concelman (BNC) interfaces. In one embodiment, the SEM device (100) includes eight ASI ports (220) with four of the ASI ports dedicated to receiving ASI input (222), while the other four ports (220) are configurable for either ASI input or output (222) signals. Thus, the SEM device (100) is equipped to receive and output transport streams of MPEG-2 program data in ASI format. Typically, each ASI port (220) can handle one transport stream at a time. The ASI input (222) transport streams may carry single or multiple service programs with information rates ranging from 50 Kbits per second to 213 Mbits per second for each transport stream. In one embodiment, the SEM device (100) can handle an aggregate information rate of up to nearly one gigabit per second (e.g., 900 Mbits per second) across all four to eight incoming ASI transport streams.

The GigE ports (210) and ASI ports (220) are configured not only to receive MPEG transport streams from the headend (110; FIG. 1) or VOD server (120; FIG. 1) in different formats, but also to output MPEG transport streams to other SEM devices (100). As a result, the cable operator may employ cascaded SEM devices (100) in a scalable fashion to increase capacity for processing transport streams. For example, FIG. 1 shows three SEM devices (100) connected together to share transport streams. In this manner a first SEM device (100) can pass a transport stream received from the VOD server (120; FIG. 1) through to another SEM device (100). Accordingly, the cable operator can cascade SEM devices (100) to increase the number of subscriber locations (150; FIG. 1) served by the headend (110; FIG. 1).

C. 10/100 Base-T Ports

The SEM device (100) can include a number of 10/100 Base-T ports (230) for receiving and transmitting 10/100 Base-T signals (232). The 10/100 Base-T ports (230) can comprise RJ-45 interfaces. Typically, the 10/100 Base-T ports (230) are configured for both input and output. As will be discussed below in more detail, the SEM device (100) generally uses the 10/100 Base-T signals (232) for control commands and feedback.

D. ASI Monitor Port

FIG. 2 further shows the SEM device (100) to include an ASI monitor port (250) for outputting any of the 16 transport streams as an ASI monitor signal (252). As will be described in more detail below, the ASI monitor port (250) and ASI monitor signal (252) allow an operator of the SEM device (100) to monitor processing of any transport streams by the SEM device (100).

E. RF Output Ports

The SEM device (100) can include a number of RF output ports (260) for transmitting RF output (262). The RF output (262) can include quadrature amplitude modulated (QAM) signals that can carry service programs to the subscriber locations (150; FIG. 1). Two transport streams may be concurrently output from each RF port (260). The input and output signals shown in FIG. 2, as well are their processing within the SEM device (100) will be described in more detail below.

III. SEM Device Components and Operation

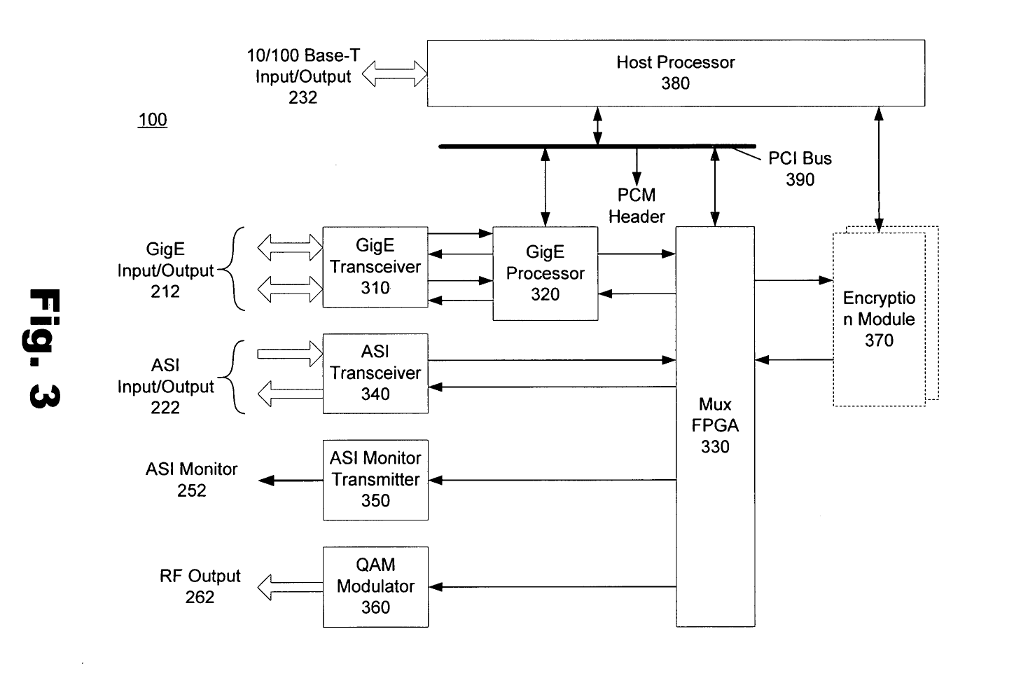

FIG. 3 is a block diagram illustrating high-level components of the SEM device (100) of FIG. 1, according to one embodiment. As shown in FIG. 3, the SEM device (100) can include a gigabit Ethernet (GigE) transceiver (310) for receiving and transmitting GigE input and output (212). The GigE transceiver (310) is coupled to a gigabit Ethernet (GigE) processor (320), which is in turn coupled to a multiplexer (Mux) field-programmable gate array (FPGA) (330) (referred to as “the Mux FPGA (330)”). GigE input (212) can be received by the GigE transceiver (310) and sent to the GigE processor (320) for processing that will be described below. The GigE processor (320) then sends the GigE input (212) to the Mux FPGA for multiplexing into internal multiple program transport streams (MPTS) in accordance with predefined logic, and for other processing that will be discussed below. The multiplexed internal transport streams can be sent back to the GigE processor (320) and GigE transceiver (310) for outputting as GigE output (212) transport streams.

FIG. 3 further shows the SEM device (100) to include an ASI transceiver (340), an ASI monitor transmitter (350), and a quadrature amplitude modulation (QAM) modulator (360) each communicatively coupled to the Mux FPGA (330). The ASI transceiver (340) is able to transmit or receive ASI input or output (222). Received ASI input (222) is sent to the Mux FPGA (330) for further processing, which will be described below. The ASI transmitter (350) can transmit the ASI monitor signal (252) to enable the cable operator to monitor performance of the SEM device (100) related to processing of any output transport stream.

The QAM modulator (360) receives multiplexed transport streams from the Mux FPGA (330) and is able to modulate the transport streams for output as RF output (262). For example, the QAM modulator (360) can modulate the transport streams up to 256-QAM for transmission to the subscriber locations (150; FIG. 1).

The internal transport streams can be selectively sent to an encryption module (370) for encryption processing. The SEM device (100) is configured to append encryption identifiers to the transport stream packets to indicate whether the transport stream should be encrypted with the encryption module (370). The encryption module (370) can be bypassed by transport streams that include a “no encryption” identifier. The appending and monitoring of the encryption identifiers will be described in more detail below.

The processing of input transport streams, internal transport streams, and output transport streams through the GigE transceiver (310), GigE processor (320), Mux FPGA (330), ASI transceiver (340), ASI monitor transmitter (350), QAM modulator (360), and encryption module (370) is controlled by a host processor (380) that is coupled to the GigE processor (310), Mux FPGA (330), and encryption module (370) via a peripheral connection interface (PCI) bus (390). The cable operator can utilize control signals (e.g., 10/100 Base-T input/output (232)) to direct or configure the host processor (380). The host processor (380) can then communicate instructions to and receive feedback signals from the GigE processor (320), Mux FPGA (330), and encryption module (370) over the PCI bus (390). The components shown in FIG. 3 and their functions will now be described in more detail in relation to a process flow of data through the components.

A. GigE Transceiver

With respect to the reception and processing of GigE input (212), MPEG-2 input transport streams in GigE format can be received by the GigE transceiver (310). The GigE transceiver can employ any technology known in the art for interfacing with SFP connector interfaces to receive and transmit GigE transport streams.

B. GigE Processor

The GigE transceiver (310) sends the received GigE transport streams to the GigE processor (320). The transport streams received from the GigE transceiver (310) are encapsulated in gigabit Ethernet frames. Each GigE frame includes an IP datagram and a User Datagram Protocol (UDP) segment having up to seven MPEG-2 transport packets from one or more unique packet identifier (PID) streams. The UDP segment may contain MPEG packets from a single or multiple service program transport streams. The GigE processor (320) can remove jitter from the MPEG Ethernet packets based on the incoming transport stream bit rate and the variable delay through the cable network. The GigE processor (320) buffers and time-stamps the incoming transport streams.

The GigE processor (320) identifies the IP addresses of the incoming packets to determine whether the packets are to be processed by the particular SEM device (100). The GigE processor (320) then peels the IP packets to their user datagram protocol (UDP) layer and informs the host processor (380) via the PCI bus (390) of what is identified as incoming input. The GigE processor (320) can be configured to append routing tags to packet streams to indicate an internal transport stream to which the packet should be routed. This selection may be based on logic loaded by the host processor (380). In one embodiment, the GigE processor (320) is based on the BCM1250 processor provided by Broadcom Corporation of Irvine, Calif. An integrated chip mulip-processor (CMP) based on the BCM1250 dual processor can be configured to perform the GigE processor (320) functions described herein.

C. Host Processor

The host processor (380) can process the packet messages in accordance with logic defined by the cable operator, thereby taking user entry into account for the processing of the packets. Based on the user-defined logic, the host processor (380) determines which data packets to filter and which data packets to encrypt and compose into a transport stream. The host processor (380) is able to instruct the GigE processor (320) and Mux FPGA (330) of how to package and build sixteen internal transport streams from the input transport streams, including setting the out-going bit rate for each of the sixteen output transport streams. In one embodiment, each of the outgoing transport streams is generated with the same rate. The process of generating up to sixteen output transport streams from the input transport streams based on user-defined logic includes functions such as buffering, demultiplexing, multiplexing, collecting MPEG program association tables (PATs), collecting MPEG program map tables (PMTs), MPEG packet identifier (PIED) aliasing, MPEG PID remapping, rate conversion, and routing. The host processor (380) is configured to work with the Mux FPGA (330) and the GigE processor (320) to perform these steps, which steps will be discussed in detail below.

D. Encryption Module

Once the internal transport streams have been generated, the encryption module 370 can encrypt any of the transport streams having an encryption identifier. As denoted by the dotted lines of the encryption module (370) shown in FIG. 3, the encryption module (370) may be implemented on a separate board. The encryption module (370) can employ any encryption method known in the art for encrypting MPEG packet transport streams. The encrypted output transport streams may then be transmitted to the GigE processor (320) and GigE transceiver (310) for transmittal to subscribers or to other units of the cable network through one of the GigE ports (210; FIG. 2).

E. ASI Transceiver

The SEM device (100) can process ASI input (222) similar to the processing of GigE input (212) described above. The ASI transceiver (340) receives ASI input (222) transport streams via the ASI ports (220; FIG. 2). The ASI transceiver (340) can perform preprocessing steps on the ASI input (222) transport stream data before sending the stream data to the Mux FPGA (330) for further processing. As will be discussed below in relation to the Mux FPGA (330), the host processor (380) can request incoming MPEG program association tables (PATs) and MPEG (program map tables (PMTs) associated with incoming ASI transport streams. Similar to the above functions performed for the GigE transport streams, the host processor (380) can instruct, based on user-defined logic, which packets are filtered and which are used to compose the sixteen internal transport streams. Encryption is selectively handled in the same way discussed above, and data is sent out either via GigE, QAM modulated, or ASI output. These functions will be described in more detail below.

F. Mux FPGA

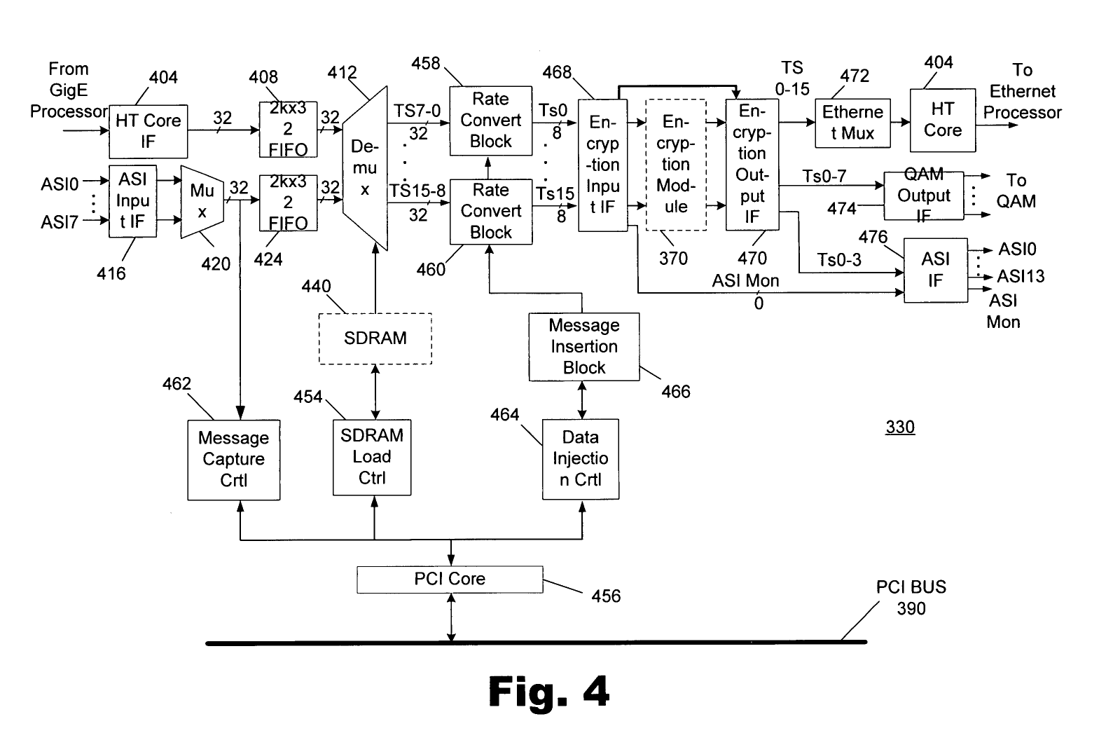

FIG. 4 is a block diagram illustrating components of the Mux FPGA (330) of FIG. 3, according to one embodiment. In one embodiment, the Mux FPGA (33) is implemented on a single integrated chip.

GigE transport streams are received from the GigE processor (320; FIG. 3) via a hyper transport core interface (404), which enables large bandwidths of data flow between the Mux FPGA (330) and the GigE processor (320; FIG. 3). The hyper transport interface (404) can be implemented by a hyper transport block of the BCM1250 processor on the GigE processor (320; FIG. 3), which HT block is known to those skilled in the art. Optimum throughput is typically achieved when 32-byte cache blocks are transferred over the hyper transport.

The GigE transport streams are received into a first-in-first-out (FIFO) buffer (408), where the transport stream packets are held before being sent to a demultiplexer (Demux) (412).

The Mux FPGA (330) is also configured to receive ASI transport streams from the ASI transceiver (340; FIG. 3). The ASI transport streams are received by an ASI input interface (IF) (416). In one embodiment, the ASI input interface (416) can concurrently receive up to eight ASI transport streams. The ASI input interface (416) can include FIFO buffers for storing packets of each ASI transport stream. The ASI input interface (416) should be configured to drop null MPEG packets from the ASI transport streams. The aggregate bit rate of the ASI inputs (222) can approach up to nearly one gigabit per second (e.g., approximately 900 Mbps). In one embodiment, the Mux FPGA (330) is configured to handle up to 8,192 unique incoming MPEG-2 service programs.

From the ASI input interface (416), the ASI transport streams travel to a multiplexer (Mux) (420), which multiplexes the ASI transport streams into a single transport stream having a bit rate equal to the aggregate of the bit rates of the incoming ASI transport streams (up to a maximum of approximately 900 Mbits per second). This single transport stream is then received by a FIFO buffer (424), where the transport stream packets are held before being sent to the demultiplexer (Demux) (412).

In one embodiment, the transport streams received by the Demux (412) comprise MPEG-2 data packets. The packet structure received at the Demux (412) can include 196 bytes, of which four bytes identify the source port that received the packet, four bytes contain a timestamp, and 188 bytes contain the MPEG-2 packet. The timestamp and source port bytes can be appended to incoming MPEG-2 packets when received by the SEM device (100). The five lowest significant bits of the first four bytes of each packet identify a target transport stream, i.e., one of the sixteen internal transport streams that will be generated by the Demux (412), to which the incoming packet will be added. The packet also contains an additional bit to differentiate between GigE transport streams and ASI transport streams to enable the SEM device (100) to recognize in which form of input the packets are encapsulated.

The Demux (412) is configured to generate internal transport streams from multiplexed ASI transport stream (now a single transport stream) and the GigE transport streams. In the embodiment shown in FIG. 3, up to sixteen internal transport streams (TS 0-15) may be formed by the Demux (412) from the GigE and ASI input streams.

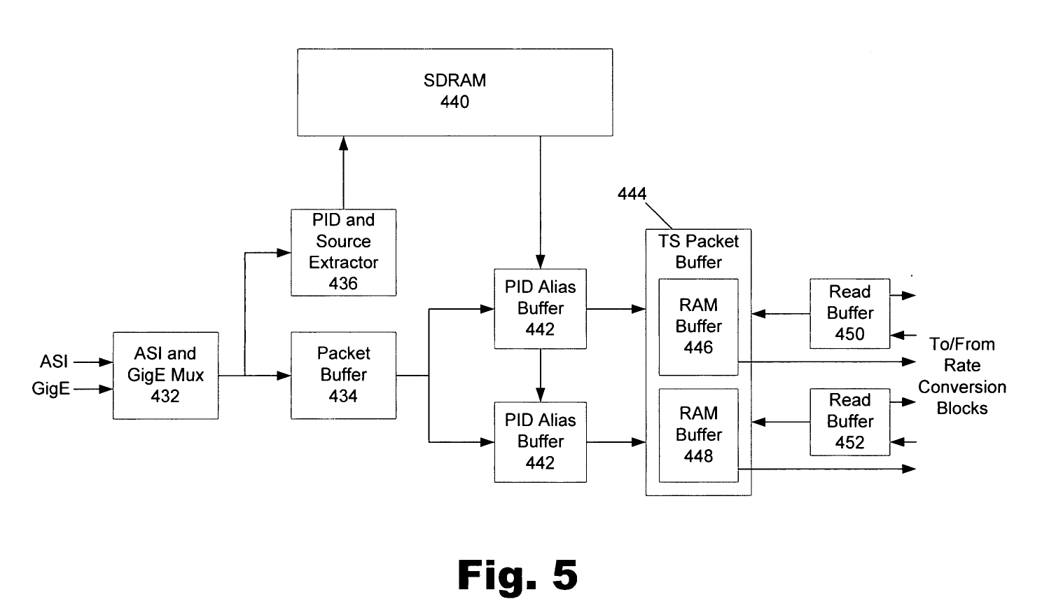

FIG. 5 is a block diagram illustrating components of the Demux (412) of FIG. 4, according to one embodiment. As shown in FIG. 5, ASI and GigE transport streams are received into the Demux (412) and multiplexed together at an ASI/GigE Mux (432). In one embodiment, the ASI/GigE Mux (432) can handle input rates of up to approximately 900 Mbits per second of aggregate input.

The multiplexed transport stream is sent from the ASI/GigE Mux (432) to a packet buffer (434) and a PID/Source extractor (436). The packet buffer (434) holds the transport stream packets while the PID/Source extractor (436) extracts packet identifiers (PIDs) and source identifiers from the packets. The packet buffer (434) can comprise a random access memory (RAM) or other suitable type of memory.

The PID/Source extractor (436) is configured to extract packet identifiers (PID) and source identifiers from the packets of the transport stream received from the ASI/GigE Mux (432). The source identifier indicates the port by which the packets were received. As mentioned above, the source identifier is appended to incoming packets of the transport streams. MPEG packet identifiers (PIDs) are known to those skilled in the art and can be used to identify particular service programs or transport streams with which packets are associated. For example, a stream of packets representative of a particular service program may carry a particular PID.

The extracted identifiers can be sent to a synchronous dynamic random access memory (SDRAM) (440), which contains a lookup table configured for using the extracted PID and source identifiers to identify new PIDs to be assigned to packets of generated internal transport streams. An embodiment of the look-up table will be discussed in more detail below. The assignment of new PIDs to the packets is referred to as PID aliasing and is utilized to allow for PID duplication/replication without introducing identical PID values into the same transport stream. This allows output transport streams to contain multiple duplicate programs because the duplicate programs are assigned unique new MPEG packet identifiers (PIDs). With this feature, the SEM device (100) can take an incoming program and replicate it multiple times across any of the sixteen internal transport streams, which allows the program to be distributed to multiple subscribers.

To enable PID duplication, the entries in the lookup table of the SDRAM 440 should include a number of options for new PID values. For example, in one embodiment, up to sixteen entries exist for every PID lookup, one for each internal transport stream. In other words, sixteen PID aliases are available for each PID lookup. Each packet can be subjected to the PID aliasing process multiple times (e.g., eight times) to allow for PID duplication.

The new PIDs are sent to two PID alias buffers (442). The PID alias buffers (442) also receive the transport stream packets from the packet buffer (434). Each of the PID alias buffers (442) receives a separate transport stream. The new PIDs are then inserted into the appropriate packets of the transport streams. The transport streams having the new PIDs are then sent to a transport stream buffer (444) having two separate RAM buffers (446, 448). The first RAM buffer (446) forms internal transport streams buffers for the received transport streams [0-7]. The second RAM (448) buffer forms internal transport stream buffers for received transport streams [8-15]. The formation of the internal transport streams, including steps for determining which incoming service programs are assigned to which internal transport stream buffers, will be discussed in further detail below in relation to the look-up table of the SDRAM (440). In one embodiment, each of the RAM buffers (446, 448) includes a buffer for each of the sixteen internal transport streams. These buffers can be configured to hold up to forty-two packets for each of the internal transport streams.

Each RAM buffer (446, 448) is read out independently by read buffers (450, 452). An arbiter is implemented for each RAM buffer (446, 448) to determine which of the eight internal transport stream buffers should be read. The generated internal transport streams are sent from the RAM buffers (446, 448) to rate conversion blocks (458, 460; FIG. 4), which will be discussed below. When any of the sixteen transport stream buffers of the RAM buffers (446, 448) is full, and its corresponding rate conversion buffer (450, 452) is full, an overflow may be flagged to reset the rate conversion buffer (450, 452).

Returning now to FIG. 4, the SDRAM (440) is in communication with the Demux (412). As discussed above, the SDRAM (440) contains a lookup table for determining transport stream demultiplexing/routing and PID aliasing. The incoming transport stream packets are passed through the lookup table. The PID identifiers and the source identifiers of the incoming transport stream packets are used to address the lookup table in the SDRAM (440). The SDRAM can include a 64 Megabit external SDRAM. Upon initialization of the SEM device (100; FIG. 1), the SDRAM (440) will be configured to drop all packets as part of power-up sequencing. The Mux FPGA (330; FIG. 3) will write zeros to all locations in memory.

As shown in FIG. 4, the SDRAM (440) is connected to an SDRAM Load Control (454), which is in turn connected with a PCI core (456). The PCI core (456) is connected to the host processor (380; FIG. 3) via the PCI bus (390). By these connections, the host processor (380; FIG. 3) is able to operate in the background to load values into the lookup table, which values reflect logic defined by the cable operator. The values are determined in advance by an operator choosing and setting parameters in the host processor (380; FIG. 3). For example, the cable operator may send a set of parameters to the host processor (380; FIG. 3) via 10/100 Base-T input (232) or any other input interface known in the art. The parameters can reflect the desired routing of transport streams and service programs based on configurations of the cable network. Thus, the cable operator is able to configure and update the lookup table to reflect current and changing configurations of the cable network.

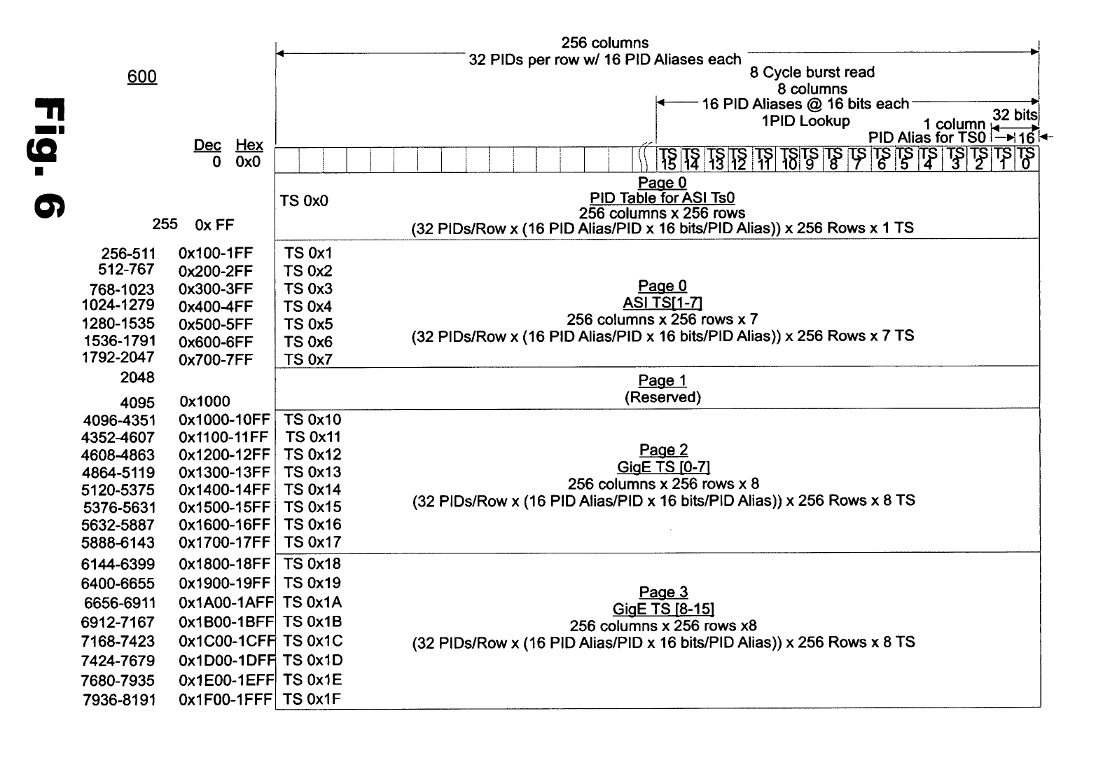

FIG. 6 is a table showing one example of a lookup table (600) that can be loaded into the SDRAM (440), according to one embodiment. As mentioned above, the lookup table (600) can be addressed by PID identifiers and source identifiers contained in incoming packet streams. Each entry in the table (600) may comprise a 16-bit field comprising an add/drop bit indicating whether to add or drop a packet, a encryption bit indicating whether to encrypt the packet, a reserved bit, and 13 bits that contain new PID values (also referred to as the PID aliases). These bits can be appended to or inserted into the packet to effectively control the aliasing and multiplexing of the packet into appropriate internal transport streams based on user-defined preferences.

Returning now to FIG. 4, the demultiplexed and aliased internal transport streams are sent from the RAM buffers (446, 448) of the Demux (412) to the rate conversion blocks (458, 460). The rate conversion blocks (458, 460) convert the bit rates of the aliased internal transport streams to programmed bit rates. The rate conversion blocks (458, 460) may utilize a FIFO RAM buffer to receive the aliased PID packets. The packets include a bit indicating whether the packet should be added or dropped. The packets are collected at the rate conversion blocks (458, 460), where the packets are converted to desired bit rates. In one embodiment, the internal transport streams can be programmed at bit rates up to approximately 213 Mbits per second.

Two different sources are included for generating bit rates for the internal transport streams. If the output is to be by QAM RF output (262; FIG. 2), the bit rate will be determined by a counter running at a QAM information clock rate. For all other output cases, the bit rate will be determined by a programmable numerically controlled oscillator (NCO). In one embodiment, the MUX FPGA (330; FIG. 3) includes eight NCOs. Each transport stream can be programmed to derive its bit rate from any of the eight NCOs.

In one embodiment, the NCO uses a twenty-two bit accumulator and a 188 down counter both running at 54 MHz. Every time the accumulator rolls over, the down counter is incremented. When the down counter count reaches zero, a packet tick is generated. The accumulator rollover rate, the packet tick rate, and thus the bit rate can be determined using the following equations, in which A is a twenty-one bit programmable offset value, RO is the accumulator rollover rate, TR is the packet tick rate, and BR is the bit rate:

$$\begin{matrix}Equation 1 \text{:} RO = ( \frac{A}{{2}^{22}} ) * 54 MHz \\ Equation 2 \text{:} 0 \leq A \leq ( {2}^{22} - 1 ) \\ Equation 3 \text{:} TR = \frac{RO}{188 * RO} \\ Equation 4 \text{:} BR = \frac{54 Mbs * A}{{2}^{19}}\end{matrix}$$

Based on the above equations, the NCO is capable of producing bit rate values from approximately 103 bits per second up to approximately 432 Mega bits per second.

A timestamp counter will be latched at each packet tick as a packet is read from the Demux (412) to the rate conversion blocks (458, 460). The latched timestamp is then compared with the appended timestamp (discussed above) to determine a program clock reference (PCR) correction value. Those skilled in the art will understand the use of the PCR correction value in the bit rate conversions performed at the rate conversion blocks (458, 460). A programmable eight-bit offset can also be added to the PCR correction value to offset fixed delays.

The programmable rate conversion for the internal transport streams allows the SEM device (100) to maximize utilization of available bandwidth. If only a few transport streams are being generated, those transport streams can be converted to higher bit rates up to an aggregate value of nearly 1 gigabit per second (e.g., 900 Mbits per second). The SEM device (100) is also able to use rate conversion to support higher numbers of transport streams by converting the bit rates to lower values that preferably add up to the maximum aggregate bit rate. In this manner, the SEM device (100) is able to assign bit rates that maximize utilization of available bandwidth for different and varying numbers of transport streams.

As shown in FIG. 4, the multiplexed ASI transport stream can be sent from the Mux (420) to a message capture control (462), which is connected with the PCI core (456). Through the message capture control (462), the host processor (380; FIG. 3) can obtain information from the ASI transport streams. For example, the host processor (380; FIG. 3) is able to request and receive program association tables (PATs) and program map tables (PMTs) associated with incoming ASI data streams. The host processor (380; FIG. 3) is configured to use this extracted information together with the user-defined lookup table to filter packets and to compose the internal transport streams from packets.

The message capture control (462) can be configured to extract messages from the incoming ASI streams. In one embodiment, the message capture control (462) can extract up to 128 PIDs and write them to memory at the host processor (380; FIG. 3). The message capture control (462) is configured to perform a parallel lookup to compare incoming PIDs against predefined filter values. When the filter identifies a packet or a message within a packet, it is extracted and written to buffers in the host processor (380; FIG. 3). In this manner, the message capture control (462) identifies messages that should be sent to the host processor (380; FIG. 3) for further processing.

As the internal transport streams are being generated, the host processor (380; FIG. 3) is able to insert or inject messages and packets into the internal transport streams. As shown in FIG. 4, the Mux FPGA (330) includes a data injection control (464) and a message insertion block (466). These components are configured to enable the host processor (380; FIG. 3) to inject message data into the internal transport streams. For example, the host processor (380; FIG. 3) can direct the insertion of IP encapsulation data, new PATs, new PMTs, and ECM/EMM (Entitlement Control Message/Entitlement Management) message templates. The host processor (380; FIG. 3) determines what messages and data to insert into particular internal transport streams based on identified entries in the lookup table. Based on the lookup table, the host processor (380; FIG. 3) is able to build PATs and PMTs that reference the new PID values of the internal transport streams.

Once the packets of the internal transport streams have been converted to desired bit rates and appropriate data messages have been inserted, the internal transport streams are sent to an encryption input interface (468). The encryption input interface (468) processes the packets of the transport streams in preparation for transmission to the encryption module (370), which may be on a board separate from the Mux FPGA (330; FIG. 3). The encryption input interface (468) can operate under different modes of operation, including a high-speed mode and a low-speed mode. In the high-speed mode, the Mux FPGA (330; FIG. 3) can output up to four transport streams to the encryption module (370), with each of the transport streams being transferred with bit rates up to approximately 160 Mbits per second limited by the maximum speed of the encryption modules (370). In the low-speed mode, the Mux FPGA (330; FIG. 3) can transmit up to 16 transport streams to the encryption module (370), with each of the transport streams having a bit rate up to approximately 54 Mbits per second. Packets sent from the encryption input interface (468) to the encryption module (370) should include four bytes containing time stamp information, four bytes containing an identifier indicating the destination transport stream (out of the sixteen transport streams), and 188 bytes of MPEG data.

The encryption module (370) can include an access control processor (ACP) configured to encrypt the transport streams according to any known encryption methods. The encryption module (370) then sends the encrypted transport streams back to the Mux FPGA (330; FIG. 3). At the Mux FPGA (330; FIG. 3), an encryption output interface (470) receives the encrypted transport streams in either the high-speed mode or low-speed mode described above in relation to the encryption input interface (468). The encrypted transport streams are now ready for processing in preparation for output from the MUX FPGA (330; FIG. 3).

Not every transport stream or program in a transport stream will be sent to the encryption module (370) for encryption. As shown in FIG. 4, the encryption module (370) can be bypassed. The Mux FPGA (330; FIG. 3) is configured to determine which transport streams will be encrypted. This selective encryption can be based on an encryption bit in the packets of the transport streams. As mentioned above, the values in the lookup table (600; FIG. 6) include a bit designating whether encryption should be performed on the packet to which the lookup value is appended. Based on the value of this bit, the Mux FPGA (330; FIG. 3) is able to selectively route transport streams to the encryption module (370) for encryption in accordance with logic specified by the cable operator.

The transport streams can be sent from the encryption output interface (470) to different interfaces for different types of output. As shown in FIG. 4, transport streams [0-15] can be sent to an Ethernet multiplexer (Mux) (472), transport streams [0-7] can be sent to a QAM output interface (IF) (474), and transport streams [0-3] can be sent to an ASI output interface (IF) (476). Each of these components will now be described in more detail.

The Ethernet Mux (472) is configured to re-mulitplex the transport streams (e.g., transport streams [0-15]) into a single transport stream. The Ethernet Mux (472) appends a time stamp and an identifier indicating the source port to each packet of the incoming transport streams. The packets for each transport stream are then stored in FIFO buffers. The packets are then read from the FIFO buffers into a multiplexer that multiplexes the transport streams into the single transport stream. The single transport stream undergoes PCR correction and is sent to the GigE processor (320; FIG. 3) via the HyperTransport (HT) core interface (404).

The QAM output interface (474) includes a channel for each of the transport streams [0-7]. The QAM output interface (474) receives an information clock signal from a QAM module (not shown) of the SEM device (100). The information clock signal is at the MPEG rate for each of the channels. The QAM output interface (474) can include FIFO buffers for each of the channels and can output one data bit from each FIFO buffer on the rising edge of each information clock cycle. The QAM output interface (474) further includes a packet counter that counts and issues packet ticks to the rate conversion blocks (458, 460). On each packet tick, an MPEG packet is converted to a serial stream and written into the FIFO buffer along with a sync bit. The sync bit will be “true” for the first bit of the MGEG packet.

Note that while only four RF output ports (260; FIG. 2) are shown in FIG. 2, each of the RF output ports (260; FIG. 2) can be configured to output two QAM RF output (262; FIG. 2) signals. The RF output (262; FIG. 2) can then be sent from the Mux FPGA (330; FIG. 3) to a QAM module (not shown) of the SEM device (100), which QAM module is able to perform further processing for transmission of service programs to the subscriber locations (150; FIG. 1).

The ASI interface (476) shown in FIG. 4 can be configured to select up to four of the sixteen transport streams to be output. The packets of the selected transport streams can be output from the ASI interface (476) in burst or byte mode. In burst mode, an entire MPEG-2 packet is sent out as a 188-byte burst. In byte mode, a byte of the MPEG packet can be sent out once every predetermined number of clock cycles (e.g., three clock cycles).

The ASI interface (476) is also configured to receive and output the ASI monitor signal (252; FIG. 2). The ASI monitor signal (252; FIG. 2) may be received from the encryption input interface (468) and stored in a FIFO buffer for output. The operator is able to access the ASI monitor signal (252; FIG. 2) to observe performance of the Mux FPGA (330; FIG. 3) in processing any transport streams.

IV. Exemplary Process Flow

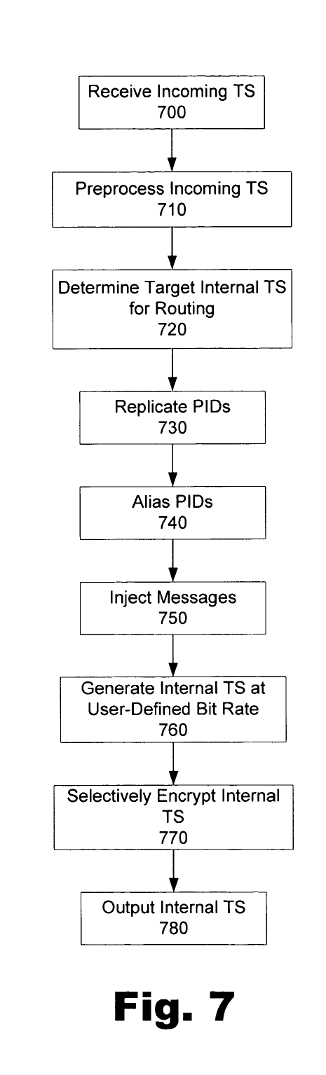

FIG. 7 is a flow diagram of an exemplary method for multiplexing MPEG transport streams, according to one embodiment. At step 700, incoming MPEG transport streams are received. In one embodiment, the incoming transport streams include both GigE and ASI MPEG data streams. At step 710, the incoming transport streams are preprocessed. This can include peeling off layers and extracting messages from the packets in any of the ways discussed above. Information taken from the packets can be selectively presented to the host processor (380; FIG. 3) for further processing related to multiplexing of the transport streams. The host processor (380; FIG. 3) runs in the background to make multiplexing determinations and to load the lookup table (600; FIG. 6) to the Mux FPGA (330; FIG. 3).

At step 720, target internal transport streams are determined for routing based on the logic in the lookup table (600; FIG. 6). The PID and source identifiers from the MPEG packets are used for addressing the lookup table (600; FIG. 6) to identify appropriate entries. The entries include data that indicates the target internal transport stream to which the incoming transport stream packets are to be routed.

At step 730, PIDs can be replicated to duplicate service programs across or within the internal transport streams. PID duplication is made possible by aliasing PIDs at step 740. New PIDs are identified in the lookup table (600; FIG. 6) entries for service programs that are to be duplicated, particularly when duplicate programs are to be routed to the same internal transport stream because the programs in a particular transport stream should include unique PIDs. PID aliasing can be performed in any of the ways discussed above.

At step 750, messages are injected in the internal transport streams. The host processor (380; FIG. 6) is able to direct the injection of messages as described above.

At step 760, the internal transport streams are generated at user-defined bit rates. The bit rates can be determined from information in the lookup table. The ability to convert transport streams to different bit rates provides the capability to maximize usage of available bandwidth based on the number of transport streams and service programs that are being processed. The bit rate conversion can be performed in any of the ways discussed above.

At step 770, the internal transport streams are selectively encrypted based on encryption bits in the packets. The encryption bits are appended to the internal transport stream packets based on the identified logic in the lookup table (600; FIG. 6). Accordingly, the encryption of transport streams can be determined based on user-defined logic.

At step 780, the internal transport streams are output. Output streams can take the form of GigE, ASI, and QAM RF signals. In one embodiment, incoming GigE transport streams can be multiplexed by the SEM device (100) as described above and output as GigE transport streams, while incoming ASI transport streams can be multiplexed and output as GigE, ASI, or QAM RF signals. In one embodiment, the aggregate rate of the output signals can reach up to nearly one gigabit per second (e.g., approximately 900 Mbits per second). Any of the functions described above can be implemented to perform the steps shown in FIG. 7.

The steps discussed above can be performed by processors being directed by instructions stored on computer-readable mediums. The instructions direct execution of the steps described above. Any type of computer-readable medium known in the art may be used. In one embodiment, SDRAM is used to store the instructions. The instructions can be in the form of software, firnware, embedded code, microcode, machine language, and the like.

V. Conclusion

In conclusion, the present apparatuses and methods described above provide capabilities for high-speed data multiplexing, routing, and selectively encrypting of MPEG transport streams of different formats. Transport stream packets can be aliased, duplicated, and multiplexed into internal transport streams for transmittal to appropriate subscriber locations. A host processor running in the background allows cable operators to define and implement logic to control the multiplexing of transport streams according to the operator's desired configuration. The logic is made accessible to a multiprocessor integrated chip for controlling multiplexing processes. The transport streams are multiplexed based on logic implemented in a lookup table with reduced latency that enables high-speed performance. Wide buses and high transmission and clock frequencies also help enable the high-speeds of the transport streams.

Moreover, the methods and apparatuses convert multiplexed transport streams to rates that utilize available bandwidth. The aggregate bit rates for the multiplexed transport streams can reach up to approximately 900 Mbits per second, according to one embodiment. In one embodiment, an MPEG-2 cross-point switch is provided that is able to handle up to approximately 900 Mbits per second of MPEG-2 data.

The apparatuses and methods allow cable operators to utilize Ethernet speeds and technologies while still leveraging deployed ASI devices. The SEM device (100; FIG. 1) described herein can be cascaded to expand network capabilities and to service increased numbers of subscribers.

VI. Alternative Embodiments

The preceding description has been presented only to illustrate and describe the present method and apparatus. It is not intended to be exhaustive or to limit the present method and apparatus to any precise form disclosed. Many modifications and variations are possible in light of the above teaching.

The foregoing embodiments were chosen and described in order to illustrate principles of the method and apparatus as well as some practical applications. The preceding description enables others skilled in the art to utilize the method and apparatus in various embodiments and with various modifications as are suited to the particular use contemplated. It is intended that the scope of the method and apparatus be defined by the following claims.

1. An apparatus for high-speed multiplexing of Motion Picture Experts Group (MPEG) transport streams in a cable network, the apparatus comprising:
an input interface configured to receive a number of transport streams carrying programming services;
a demultiplexer configured to access user-defined logic and to generate a number of internal transport streams based on said user-defined logic, said demultiplexer being configured to add said programming services to at least one of said number of internal transport streams based on said user-defined logic; and
an output interface configured to output said number of internal transport streams.

2. The apparatus of claim 1, further comprising a rate conversion block configured to convert said number of internal transport streams to selectable bit rates, said bit rates being determined based on said user-defined logic.

3. The apparatus of claim 2, wherein said rate conversion block is configured to select said bit rates from eight available bit rates.

4. The apparatus of claim 2, wherein said rate conversion block is configured to select said bit rates based on the number of said number of internal transport streams.

5. The apparatus of claim 2, wherein said rate conversion block is configured to insert messages into said number of internal transport streams based on said user-defined logic.

6. The apparatus of claim 1, further comprising encryption interfaces configured for providing said number of internal transport streams to an encryption module and for receiving encrypted said number of internal transport streams from the encryption module.

7. The apparatus of claim 6, wherein said encryption interfaces are configured to selectively send each of said number of internal transport streams to the encryption module based on said user-defined logic.

8. The apparatus of claim 1, wherein said demultiplexer is configured to access new packet identifiers (PIDs) in said user-defined logic based on source identifiers and incoming packet identifiers associated with said number of transport streams.

9. The apparatus of claim 8, wherein said demultiplexer is configured to assign said new packet identifiers (PIDs) to packets of said number of internal transport streams.

10. The apparatus of claim 1, wherein said demultiplexer is configured to duplicate said programming services across any of said number of internal transport streams based on said user-defined logic.

11. The apparatus of claim 1, wherein said number of transport streams have an aggregate bit rate of approximately 900 Megabits per second.

12. The apparatus of claim 1, wherein said number of internal transport streams have an aggregate bit rate of approximately 900 Megabits per second.

13. The apparatus of claim 1, wherein said input interface is configured to concurrently receive up to 1,024 said transport streams via Gigabit Ethernet (GigE) inputs.

14. The apparatus of claim 1, wherein said input interface is configured to receive up to eight said transport streams via asynchronous serial interface (ASI) inputs, each of said up to eight said transport streams including a plurality of said programming services.

15. The apparatus of claim 1, wherein said number of internal transport streams includes up to sixteen said internal transport streams.

16. The apparatus of claim 1, wherein said demultiplexer is configured to multiplex said programming services into said number of internal transport streams based on said user-defined logic, said user-defined logic being contained in a lookup table accessible by said demultiplexer.

17. The apparatus of claim 16, wherein said demultiplexer is configured to perform said multiplexing at approximately 900 Megabits per second.

18. The apparatus of claim 1, wherein said output interface is configured to distribute said number of internal transport streams for Gigabit Ethernet output, quadrature amplitude modulation (QAM) output, and asynchronous serial interface (ASI) output.

19. A method for high-speed multiplexing of Motion Picture Experts Group (MPEG) transport streams in a cable network, the method comprising:
receiving a number of transport streams carrying programming services;
accessing user-defined logic;
generating a number of internal transport streams based on said user-defined logic; and
adding said programming services to at least one of said number of internal transport streams based on said user-defined logic.

20. The method of claim 19, further comprising converting said number of internal transport streams to selectable bit rates, said bit rates being determined based on said user-defined logic.

21. The method of claim 20, further comprising selecting said bit rates from eight available bit rates.

22. The method of claim 20, wherein further comprising selecting said bit rates based on the number of said number of internal transport streams.

23. The method of claim 20, further comprising inserting messages into said number of internal transport streams based on said user-defined logic.

24. The method of claim 19, further comprising:
selectively providing said number of internal transport streams to an encryption module based on said user-defined logic; and
receiving encrypted said number of internal transport streams from the encryption module.

25. The method of claim 19, wherein said step of accessing includes locating new packet identifiers (PIDs) in said user-defined logic based on source identifiers and incoming packet identifiers associated with said number of transport streams.

26. The method of claim 25, further comprising assigning said new packet identifiers (PIDs) to packets of said number of internal transport streams.

27. The method of claim 19, further comprising duplicating said programming services across any of said number of internal transport streams based on said user-defined logic.

28. The method of claim 19, wherein said number of transport streams have an aggregate bit rate of approximately 900 Megabits per second.

29. The method of claim 19, wherein said number of internal transport streams have an aggregate bit rate of approximately 900 Megabits per second.

30. The method of claim 19, wherein said step of receiving includes concurrently taking in up to 1,024 said transport streams via Gigabit Ethernet (GigE) inputs.

31. The method of claim 19, wherein said step of receiving includes concurrently taking in up to eight said transport streams via asynchronous serial interface (ASI) inputs, each of said up to eight said transport streams including a plurality of said programming services.

32. The method of claim 19, wherein said steps of generating and adding are performed at approximately 900 Megabits per second.

33. The method of claim 19, further comprising outputting said number of internal transport streams, wherein said step of outputting includes distributing said number of internal transport streams for Gigabit Ethernet output, quadrature amplitude modulation (QAM) output, and asynchronous serial interface (ASI) output.

34. A processor-readable medium having instructions thereon for enhancing high-speed multiplexing of Motion Picture Experts Group (MPEG) transport streams in a cable network, said instructions being configured to instruct a processor to perform the steps of:
receiving a number of transport streams carrying programming services;
accessing user-defined logic;
generating a number of internal transport streams based on said user-defined logic; and
adding said programming services to at least one of said number of internal transport streams based on said user-defined logic.

35. The processor-readable medium of claim 34, wherein said instructions are configured to cause the processor to perform a step of converting said number of internal transport streams to selectable bit rates, said bit rates being determined based on said user-defined logic.

36. The processor-readable medium of claim 35, wherein said instructions are configured to cause the processor to perform a step of selecting said bit rates from eight available bit rates.

37. The processor-readable medium of claim 35, wherein said instructions are configured to cause the processor to perform a step of selecting said bit rates based on the number of said number of internal transport streams.

38. The processor-readable medium of claim 35, wherein said instructions are configured to cause the processor to perform a step of inserting messages into said number of internal transport streams based on said user-defined logic.

39. The processor-readable medium of claim 34, wherein said instructions are configured to cause the processor to perform the steps of:
selectively providing said number of internal transport streams to an encryption module based on said user-defined logic; and
receiving encrypted said number of internal transport streams from the encryption module.

40. The processor-readable medium of claim 34, wherein said step of accessing includes locating access new packet identifiers (PIDs) in said user-defined logic based on source identifiers and incoming packet identifiers associated with said number of transport streams.

41. The processor-readable medium of claim 40, wherein said instructions are configured to cause the processor to perform a step of assigning said new packet identifiers (PIDs) to packets of said number of internal transport streams.

42. The processor-readable medium of claim 34, wherein said instructions are configured to cause the processor to perform a step of duplicating said programming services across any of said number of internal transport streams based on said user-defined logic.

43. The processor-readable medium of claim 34, wherein said step of receiving includes concurrently taking in up to 1,024 said transport streams via Gigabit Ethernet (GigE) inputs.

44. The processor-readable medium of claim 34, wherein said step of receiving includes concurrently taking in up to eight said transport streams via asynchronous serial interface (ASI) inputs, each of said up to eight said transport streams including a plurality of said programming services.

45. The processor-readable medium of claim 34, wherein said steps of generating and adding are performed at approximately 900 Megabits per second.

46. The processor-readable medium of claim 34, wherein said instructions are configured to cause the processor to perform a step of outputting said number of internal transport streams, wherein said step of outputting includes distributing said number of internal transport streams for Gigabit Ethernet output, quadrature amplitude modulation (QAM) output, and asynchronous serial interface (ASI) output.
